(19) United States
(12) Patent Application Publication
(10) Pub. No.: US 2019/0121308 A1
(43) Pub. Date: Apr. 25, 2019

(54) METHOD FOR ASCERTAINING AN OPTIMUM STRATEGY

(71) Applicant: SIEMENS AKTIENGESELLSCHAFT, Muenchen (DE)

(72) Inventors: Vladimir Danov, Erlangen (DE); Sebastian Thiem, Nurnberg (DE)

(21) Appl. No.: 16/192,287

(22) PCT Filed: Mar. 1, 2017
(86) PCT No.: PCT/EP2017/054696

§ 371 Date: Nov. 15, 2018

(30) Foreign Application Priority Data
May 18, 2016 (DE) 10 2016 208 507.7

(51) Int. Cl. G05B 19/042

(52) U.S. Cl. CPC G05B 19/042; G05B 2219/2639

(57) ABSTRACT

Provided is a method for ascertaining an optimum strategy, having the following steps: a controller receiving at least one input value and an operating state of at least one installation unit of an installation, the controller performing an FDP algorithm to optimise a parameter on the basis of the at least one input value and the operating state, wherein the installation behaviour of the installation is predicted for a predefined plurality of strategies for a particular period of time, ascertaining an optimum strategy from the predefined plurality of strategies by taking into consideration at least one termination condition, and applying the optimum strategy to the at least one installation unit. Further, embodiments of the invention relates to a model-predictive controller and to a computer program for performing the method steps.

### CROSS-REFERENCE TO RELATED APPLICATIONS

This application claims priority to PCT Application No PCT/EP2017/054696, having a filing date of Mar. 1, 2017, based off of German Application No. 10 2016 208 507.7, having a filing date of May 18, 2016, the entire contents both of which are hereby incorporated by reference.

### FIELD OF TECHNOLOGY

The following relates to a method for ascertaining an optimum strategy. The ascertained strategy can be applied to an energy installation and is geared to improving the operation of the installation in respect of a parameter that is to be optimized.

### BACKGROUND

Such installations are known from the known art and have two functional components or installation units, namely an energy conversion unit (EWE) and an energy store (ES). The EWE in this instance can convert electrical energy into thermal energy and, by way of example, may be in the form of a compression refrigeration machine, a heat pump or an electric boiler. The ES is in particular a thermal energy store (TES) (e.g. hot water reservoir or ice store). In this patent application, the exemplary installation having a compression refrigeration machine and an energy store is discussed in detail.

The installation and the installation units thereof can be operated by a controller, in particular a model-predictive controller. In this regard, the controller can influence different manipulated variables. The installation units may have different manipulated variables. By way of example, the EWE has only a few manipulated variables (switch on ON or switch off OFF). In this case, the controller can control which compressor or which compressors of the compression refrigeration machine are meant to be switched on or switched off.

An exemplary requirement for the control of such installations is the operation thereof optimized in terms of operating cost.

In the course of the Energiewende, variable electricity prices (or prices of electric power) have been introduced that can be used for optimizing operating costs. The electricity prices change every 15 minutes according to the current market situation.

The variable electricity prices are an expression of the following technical facts:

In particular the rising proportion of renewable energies (such as, for example, wind power, photovoltaics or hydroelectric power, etc.) means that the availability of electric power fluctuates greatly. High supply of electric power results in low electricity prices. By contrast, low supply of electric power is reflected in high electricity prices.

Methods for optimizing operating costs are known from the known art. Some known methods are based on simple heuristics. Depending on the electricity price, a determined, for the most part very simple, manner of operation is chosen. When the electricity price is low, the EWE is switched on, and when the electricity price is high, the EWE is shut down. If the ES connected thereto is already full, this exemplary heuristic is not appropriate, however. The refrigeration machine would then need to be forcibly shut down again.

A disadvantage of the simple heuristic is therefore that this heuristic is not an optimization and in many cases does not deliver satisfactory results.

Other methods are based on simplified models in which operation is optimized in advance for the next day. Therefore, the methods are not capable of predicting the installation behavior exactly or to a very good approximation. By way of example, these methods involve the final state of charge of the ES at the end of the optimization horizon being stipulated by a periodic constraint. By way of example, the state of charge after a period of 24 hours is chosen to be the same as the initial state of charge (what is known as a periodic constraint). The periodic constraint is a hard condition, however. Accordingly, a situation may arise in which the electricity price is extremely low in a period of 24 hours, for example, and the ES should be charged in order to save costs in the following period. This exemplary scenario cannot be modeled with a periodic constraint.

A disadvantage of this is therefore that the simplified models are not predictive and do not lead to a satisfactory optimization result. Furthermore, more complex manners of operation of the installation or installation behaviors can also be modeled only inadequately.

In other words, the above methods for optimizing operating costs stipulate a fixed and very simple strategy or manner of operation for the future on the basis of electricity prices known before then.

The methods are therefore unsuitable for also optimizing other factors or parameters flexibly in addition or as an alternative to the above operating costs, in particular factors that can change over time. Further, the methods do not adequately acknowledge the variable electricity prices and other variable received variables. Besides electricity prices, outside temperatures, thermal or electrical loads, etc. likewise need to be taken into consideration, for example. This means that the conventional methods cannot flexibly be adapted, react to changes and in so doing model complex manners of operation.

Embodiments of the present invention is therefore based on the object of providing an automated method for ascertaining an optimum strategy that can take into consideration variable received variables, can model complex manners of operation and is likewise applicable to any installations.

### SUMMARY

An aspect relates to a method for ascertaining an optimum strategy, having the following steps:
a. a controller receiving at least one received value and an operating state of at least one installation unit of an installation;
b. the controller taking the at least one received value and the operating state as a basis for performing an FDP algorithm to optimize a parameter, wherein the installation behavior of the installation is predicted for a determined period of time for a predefined plurality of strategies;
c. ascertaining an optimum strategy from the predefined plurality of strategies taking into consideration at least one termination condition; and
d. applying the optimum strategy to the at least one installation unit.

As already set out in detail earlier on, an energy installation having one or more installation units is operated by a controller. To this end, the controller can additionally or alternatively have one or more units.

The controller receives one or more received values and an operating state of an installation unit. These serve as an input or as input values for an optimization algorithm. By way of example, the received value is a piece of market information, such as the variable energy price, electricity price or the temperature, and the operating state is the state of charge of the ice store. In embodiments of the present invention, the forward dynamic programming (FDP) algorithm is used as the optimization algorithm. It has been found that the FDP algorithm is particularly well suited to taking into consideration nonlinear models.

The controller internally calls the FDP algorithm. The input values taken by the FDP algorithm are the received values and additionally or alternatively further values. Further, the FDP algorithm takes these as a basis for ascertaining a plurality of predefined strategies as an output. In other words, the FDP algorithm is regularly (for example in predefined time steps) called in order to output the plurality of strategies as outlined.

Accordingly, each strategy of the plurality of strategies is directed at a manner of operation, namely how one or more installation units (the compression refrigeration machine and/or the ice store) can be operated with the parameter to be optimized. By way of example, the strategies with which the installation can be operated at minimum operating costs or with another technical condition to be optimized are meant to be ascertained. In this case, the constraints of the installation, such as system limitations, are heeded and observed in order to ensure smooth operation of the installation.

In one exemplary case, the strategy has a manipulated variable that can be used to operate the installation unit. The installation unit may be the compression refrigeration machine, and the manipulated variable may be a manipulated variable for the compression refrigeration machine, in the latter case the switching-on or switching-off of one or more compressors of the refrigeration machine, for example. Accordingly, three strategies can be defined, and output by the FDP algorithm, for example, as follows: (1) all compressors off, (2) compressor 1 or 2 on, and (3) compressors 1 and 2 on.

Next, the optimum strategy is selected from the plurality of strategies (1) to (3). To take up the above example, the first strategy (1, all compressors off) is selected from the possible three strategies. This selection method involves at least one termination condition being heeded. The termination condition is explained in detail later on.

The optimum strategy is applied to the installation unit, in this case for example strategy (1) to the compression refrigeration machine. As a result of the compression refrigeration machine being switched off, the operating state of another installation unit coupled thereto can also change. In the present example, the compression refrigeration machine is coupled to the ice store via a pipe. The state of charge of the ice store changes accordingly.

An advantage of the method according to embodiments of the invention can be seen in that variable received variables (such as electricity prices or temperature, etc.) can be taken into consideration. Additionally, as a further advantage, the method can be applied to very complex installations and installation models. This significantly improves the optimization result as a whole in comparison with conventional methods, and the installation can quickly and flexibly react to any changes on the basis of the optimum strategy.

The FDP algorithm can additionally take into consideration a storage model, wherein the storage model has the installation behavior of the at least one installation unit on the basis of the previous operating state of said installation unit. Besides the plurality of received values, the optimization algorithm can additionally take into consideration one or more storage models. In this instance, each storage model describes the installation behavior or the manner of operation of an installation unit on the basis of its prior operation. As described earlier on, the operating state of the ice store changes on the basis of the compression refrigeration machine. The preceding state of charge can differ from the present state of charge. By way of example, the ice store has previously been charged to 80% and subsequently discharged to 40%, accordingly partially charged and discharged. As a result, the change over time can be tracked and taken into consideration in the optimum strategy in order to model the installation behavior in the best possible way and completely.

The at least one termination condition may be a power loss as a result of an installation unit being switched on. When an installation unit is switched on (also called starting up), for example the compression refrigeration machine is switched on, it consumes additional electricity. This energy loss can advantageously also be taken into account in the selection of the optimum strategy from the possible strategies.

The parameter to be optimized and/or the at least one received value can change over time, such as refrigeration load, temperature or air pressure. Accordingly, the parameter can relate to a value of the installation that is ascertained by means of a sensor, for example, and can change rapidly relative to the inertia of the installation to be controlled (e.g. at intervals of minutes). By contrast, the operating state of the installation unit, such as the ice store, changes only within a larger period of time (e.g. at least half an hour or one full hour) on the basis of the operation of the installation. The parameter is optimized according to embodiments of the invention by the FDP algorithm. Besides the operating state, the FDP algorithm is provided with further input values, namely the aforementioned at least one received value. The received value can relate to market information or market predictions or likewise to a value of the installation. Advantageously, the FDP algorithm works on latest and reliable received variables. This also improves the optimum strategy in terms of dependability.

The temperature can be ascertained by means of a temperature prediction. Accordingly, it is possible to use latest predictions can be used as a result of Internet queries for the temperature, for example.

The refrigeration load may be an empirical value or a simulated value from a cooling system. Predictions or empirical values can also be used for the refrigeration load.

The at least one received value can be received by the controller via an interface, in particular an energy agent. The controller can have one or more interfaces for receiving the input values. For energy-related received values, the interface used can be an energy agent, for example, which is in the form of software or an application, for example.

The parameter to be optimized and/or the at least one received value may be a resource whose availability varies over time, such as fuel, costs, price or energy. By way of example, the parameter to be optimized may be the operating costs, and the received value may be a power-related (and additionally energy-related) electricity price. In the case of the electricity price, the controller is provided with an electricity price update from an electricity supplier for e.g. the next 24 hours, or the electricity price is negotiated with a further market unit (e.g. balance master).

Alternatively, however, any other parameter can be optimized with the FDP algorithm in the same manner using the method according to embodiments of the invention, and any other received variable can also be taken into consideration by the FDP algorithm. As a result, the method according to embodiments of the invention is flexible, freely adaptable and applicable to changes. In this respect, the outside ambient conditions, influences or the installation behavior (and the installation units of said installation) can rapidly change and therefore be taken into consideration.

The installation unit is in the form of an energy store or a compression refrigeration machine, and/or each strategy has a manipulated variable for the at least one installation unit. The energy installation has two or more installation units, in particular the energy store and the compression refrigeration machine, that are connected to one another via appropriate pipes. As a result of a manipulated variable being applied to an installation unit, for example switching on or switching off the compression refrigeration machine, the installation behavior or the operating state of another installation unit, such as the ice store, also changes. The installation can alternatively or additionally have other installation units.

The operating state is the state of charge of an installation unit, in particular of the ice store, and the optimum strategy having the manipulated variable is applied to another installation unit, in particular the compression refrigeration machine, in step d., the manipulated variable being the switching-on or switching-off of a compressor. In the example of embodiments of the present invention, the compression refrigeration machine is operated using the ascertained strategy (1). Since said compression refrigeration machine is coupled to the ice store, its state of charge changes accordingly. The state of charge and the manipulated variable can alternatively also relate to the same installation unit, however.

The present operating state of the installation unit is sent to the controller after step d. in order to update the operating state in step a. Advantageously, the changed state of charge of the ice store is sent to the controller after the manipulated variable has been applied to the compression refrigeration machine. This ensures that the controller and the FDP algorithm use latest values as input values and adapt the optimum strategy as appropriate.

The FDP algorithm additionally complies with at least one constraint, in particular a coverage of the load or a system limitation. When the FDP algorithm is performed, secondary conditions or limitations of the installation, such as capacity limits of the installation units, need to be observed in order to guarantee the smooth and correct operation of the installation.

### BRIEF DESCRIPTION

Some of the embodiments will be described in detail, with reference to the following figures, wherein like designations denote like members, wherein:

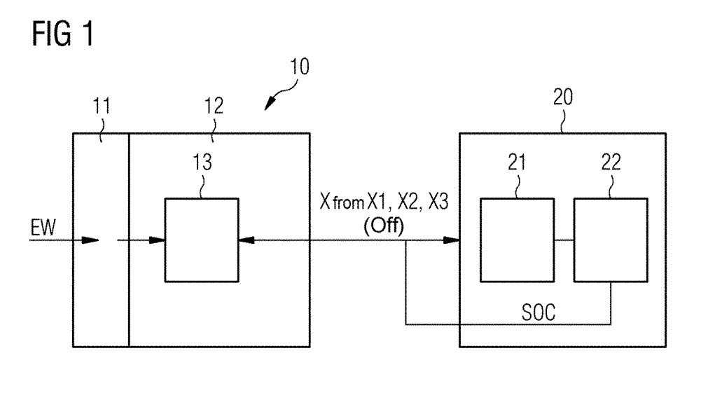

FIG. 1 shows a model-predictive controller for performing the method for ascertaining an optimum strategy;

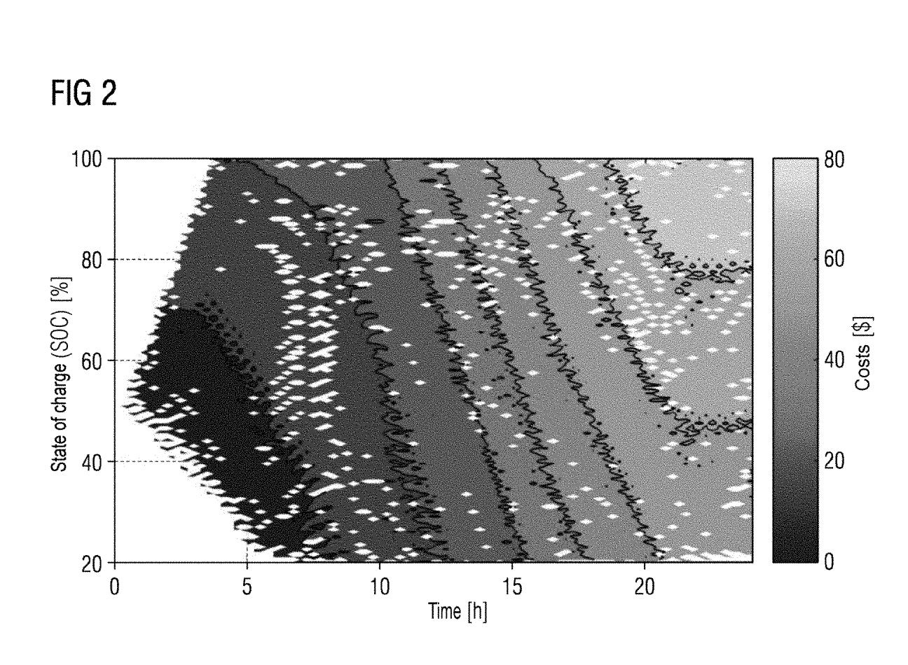

FIG. 2 shows a schematic solution field for the FDP algorithm; and

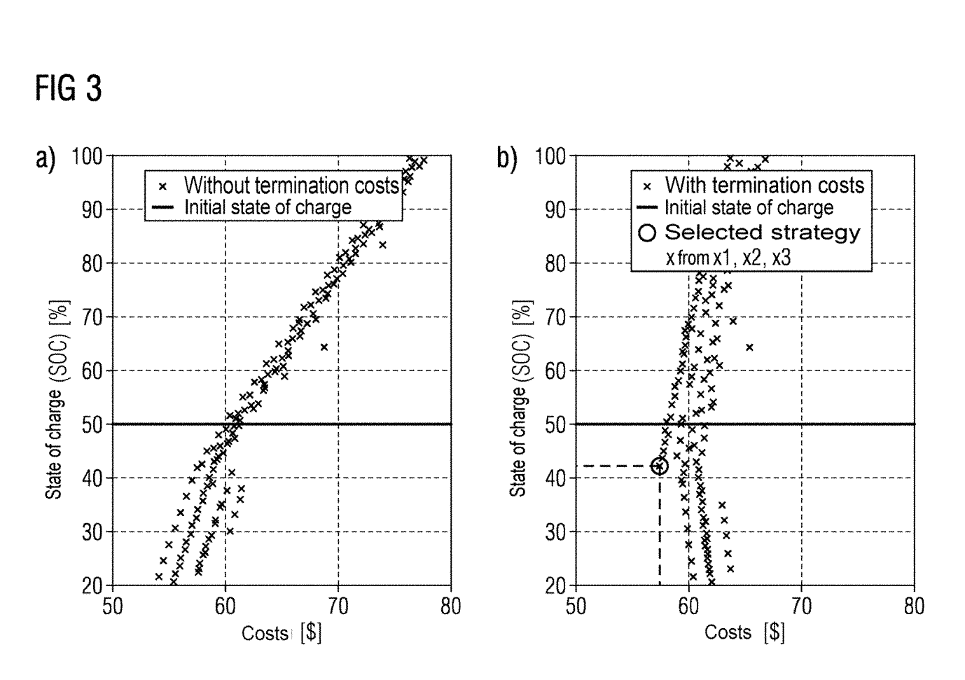

FIG. 3 shows a schematic graph of the state of charge (SOC) of the ice store (ES) against the costs (a) without the introduction of additional costs and (b) with the introduction of additional costs.

### DETAILED DESCRIPTION

Exemplary embodiments of the present invention are described below with reference to the accompanying figures.

In the exemplary case shown in FIGS. 1 to 3, the operating costs are optimized as the parameters to be optimized. As already described earlier on, the method according to embodiments of the invention is not limited to the optimization of operating costs, but rather any other parameter, such as temperature, etc., can be optimized alternatively.

FIG. 1 shows a model-predictive controller 10 according to embodiments of the invention. The model-predictive controller 10 carries out the method according to embodiments of the invention for ascertaining an optimum strategy x. The optimum strategy x is intended to be used to control the installation 20 in optimized fashion.

The method according to embodiments of the invention is explained in detail below with reference to FIG. 1 first of all.

In one embodiment of the invention, the model-predictive controller 10 has an interface 11 (for example to an energy agent) and a control unit 12. The control unit 12 uses the interface 11 to receive one or more received values EW for an optimization algorithm 13, in particular the FDP algorithm. Besides the received values EW, the control unit 12 likewise receives an operating state SOC of an installation unit 21, 22 of the installation 20.

The control unit 12 of the controller 10 or another unit of the controller 10 internally calls the FDP algorithm in predetermined time steps (for example every 15 minutes). The FDP algorithm takes the received values EW and the operating state SOC as the input. The received values EW comprise the variable electricity prices, as an example. The operating state SOC may be the state of charge SOC of the ice store 22, for example. Additionally, the FDP algorithm 13 can take into consideration further values or storage models and is required to observe constraints, such as, for example, the capacity limits of the ice store ES.

On the basis of the input, the FDP algorithm ascertains an optimum strategy for a predetermined period of time (for example for 24 hours), which strategy can be used to operate the installation at minimum operating costs (or under another parameter that is to be optimized). The period of time can also be called the optimization horizon. When the FDP algorithm is applied, discretization in the time (15-minute time step) and discretization in the state of charge of the ice store (0.5% SOC) first of all take place. The resulting solution field for the optimization algorithm is shown in FIG. 2.

In other words, a plurality of predefined strategies x1, x2, x3 are ascertained for a determined SOC in % (on the y axis) and a predetermined time step in minutes (on the x axis) at minimum operating costs. In this instance, the time step can be set as desired. The operating costs are depicted in shades of grey. Each point x in the solution field represents a vector or a plurality of predefined strategies x1, x2, x3. In our exemplary case, the compression refrigeration machine 21 comprises two compressors and, as manipulated variables, switching on ON/switching off OFF. This results in three strategies, for example, with: (1) all compressors off denoted as x1, (2) compressor 1 or compressor 2 on denoted by x2, and (3) compressors 1 and 2 on denoted by x3, as already explained earlier on.

In another embodiment of the invention, the controller can also have other units or interfaces for performing the method according to embodiments of the invention, however.

In a further aspect of embodiments of the invention, the optimum strategy is selected by taking into consideration one or more termination conditions. In the case of optimization of the operating costs, advantageously additional costs (what are known as termination costs) are introduced. The additional costs are applied to the operating costs to be minimized. The mathematical equations for determining the termination costs are depicted and explained below.

In other words, the operating costs have additional costs applied to them, what are known as the termination costs, in order to achieve the most cost-effective of the ascertained strategies. Without the introduction of the termination costs, the strategy would attempt to empty the ice store after the predetermined period of time (for example 24 hours). This means that the state of charge (SOC) falls to a minimum of 0%.

From the prior art it is known practice to introduce a periodic constraint that sets the state of storage or state of charge at the end of the 24 hours to be the same as the initial state of charge, as already described earlier on. The introduction of the termination costs has been found to be more advantageous for the operating costs. When considered over multiple periods, a significantly better optimization result and accordingly lower operating costs are attained in contrast to the prior art.

The operating costs are the latest costs or operating costs C for the discrete time step k as follows, where k is a time step of 15 minutes, for example, C_el,e is the energy-related electricity costs, and C_su is the startup costs:

C^{k}=C_{el,e}^{k}+Cₛᵤ^{k},

If no additional costs are introduced, the optimization algorithm 13 will discharge the ice store 22 completely at the end of the optimization horizon (period of 24 hours). To prevent this, virtual termination costs are introduced. Both the final state of charge and the operating state of the compression refrigeration machine 21 are compared with their first or initial operating states (at the start of the optimization period). Accordingly, the termination costs are defined as follows:

$${C}_{SOC}^{N} = - \frac{{\overline{p}}_{el , e}}{\overline{EER}} {E}_{ITES , cap} ( {SOC}^{N} - {SOC}^{0} ) ,$$

where
the superscript N is the number of discrete time steps k, C is the operating costs, P_el_e_bar is an average electricity price (averaged over the number of data items available: week, month or year), E_ITES,cap is the storage capacity of the ice store, SOC^{N} and SOC⁰ are the final (there are several of them—the points x in FIG. 3) and initial states of charge of the store SOC, EER_bar is an average energy efficiency ratio (which means the efficiency of the refrigeration machine 21). EER_bar needs to be determined beforehand and is a constant parameter in this equation.

By taking into consideration the average electricity price, optimization periods in which the electricity price tends to be low are left with a higher SOC. Similarly, periods with a low outside temperature and therefore with higher efficiency for compression refrigeration machines 21 (vice-versa for heat pumps) tend to be left with a higher SOC. Consequently, this results in selection of the final state of charge of the optimization problem, which compares the constraints of the latest 24 hours against the constraints of other periods.

A further aspect of embodiments of the invention is to take into consideration further operating states of other installation units 21, 22 in addition or as an alternative to the state of charge of the ice store 22. An exemplary further operating state is the present operating state of the refrigeration machine 21 (e.g. (1) compressors off, 1 compressor on, 2 compressors on, etc.). If e.g. a compressor 21 is on at the beginning of the optimization horizon or the period (24 hours) and said compressor is switched off at the end of the 24 hours, this may be disadvantageous and accordingly worse in comparison with a strategy with a similar final state of charge of the store but the compressor still activated. Accordingly, startup costs are additionally taken into consideration by way of p_su,c. Startup costs are costs arising when a compressor is switched on. On startup, energy is consumed before the full refrigeration power is available. Further, startup has an influence on the life of the installation. The termination costs are therefore defined as follows:

C_{CC}^{N}=Σ_{c=1}^{K=2}(b_{sd,c}^{N},p_{su,c}), where

the further integer variable (b_{sd,c}^{N}{−1,0,1}) determines whether the compressor 21 has a different operating state at the end of the optimization period in comparison with at the beginning of the optimization period. By way of example, the value is 1 if the compressor was switched off at the end and switched on at the start.

In other embodiments (not depicted), other parameters can be optimized in addition or as an alternative to the above operating costs. The operating costs are just an expression of one technical condition. Instead of the termination costs, other intermediate steps or termination conditions can also be applied in this case in order to determine the optimum strategy from the plurality of strategies.

The method according to embodiments of the invention can also be transferred to another exemplary case, such as an electric car. Electric cars are known from the prior art and usually have an energy store in the form of a storage battery for storing energy and further an interface for connection to a power grid. The energy store can be charged and discharged. By way of example, the energy store can be charged in a few minutes by fast charging stations, or the electricity can flow into the energy store from photovoltaic installations when the sun is shining. The applicable operating state or state of charge of the energy store (SOC) can be monitored by the model-predictive controller 10 according to embodiments of the invention, which can perform the method. In this case too, the consumption of electric power, for example excess electricity, can be taken into consideration. The excess electricity can advantageously either be used for driving the car or can even flow from the parked car back to the power grid, depending on requirements.

The processes or method sequences described above can be implemented on the basis of instructions that are present on computer-readable storage media or in volatile computer memories (subsequently referred to as computer-readable memories in summary). By way of example, computer-readable memories are volatile memories such as caches, buffers or RAM and also nonvolatile memories such as removable data storage media, hard disks, etc.

The functions or steps described above may in this instance be available in the form of at least one set of instructions in/on a computer-readable memory. The functions or steps in this instance are not tied to one particular set of instructions or to one particular form of sets of instructions or to one particular storage medium or to one particular processor or to particular execution schemes and can be executed by software, firmware, microcode, hardware, processors, integrated circuits, etc., operating on their own or in any combination. In this instance, a wide variety of processing strategies can be used, for example serial processing by a single processor or multiprocessing or multitasking or parallel processing, etc.

The instructions may be stored in local memories, but it is also possible for the instructions to be stored on a remote system and to be accessed via a network.

The term “processor,” “central signal processing,” “control unit” or “data evaluation means,” as used here, comprises processing means in the broadest sense, that is to say, by way of example, servers, general purpose processors, graphics processors, digital signal processors, application-specific integrated circuits (ASICs), programmable logic circuits such as FPGAs, discrete analog or digital circuits and any combinations of these, including all other processing means known to a person skilled in the art or developed in future. Processors can in this instance consist of one or more apparatuses. If a processor consists of multiple apparatuses, these may be configured for the parallel or sequential processing of instructions.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for ascertaining an optimum strategy, having the following steps:
a. a controller receiving at least one received value and an operating state of at least one installation unit of an installation;
b. the controller taking the at least one received value and the operating state as a basis for performing an FDP algorithm to optimize a parameter, wherein the installation behavior of the installation is predicted for a determined period of time for a predefined plurality of strategies;
c. ascertaining an optimum strategy from the predefined plurality of strategies taking into consideration at least one termination condition; and
d. applying the optimum strategy to the at least one installation unit.

2. The method as claimed in claim 1, wherein the FDP algorithm can additionally take into consideration a storage model, wherein the storage model has the installation behavior of the at least one installation unit on the basis of the previous operating state of said installation unit.

3. The method as claimed in claim 1, wherein the at least one termination condition may be a power loss as a result of an installation unit being switched on.

4. The method as claimed in claim 1, wherein the parameter to be optimized and/or the at least one received value can change over time, such as refrigeration load, temperature or air pressure.

5. The method as claimed in claim 4, wherein the temperature is ascertained by means of a temperature prediction.

6. The method as claimed in claim 4, wherein the refrigeration load may be an empirical value or a simulated value from a cooling system.

7. The method as claimed in claim 1, wherein the at least one received value is received by the controller via an interface, in particular an energy agent.

8. The method as claimed in claim 1, wherein the parameter to be optimized and/or the at least one received value may be a resource whose availability varies over time, such as fuel, costs, price or energy.

9. The method as claimed in claim 1, wherein the at least one installation unit is in the form of an energy store or a compression refrigeration machine, and/or wherein each strategy has a manipulated variable for the at least one installation unit.

10. The method as claimed in claim 1, wherein the operating state is the state of charge of the at least one installation unit of the ice store, and the optimum strategy having the manipulated variable is applied to another installation unit, in particular the compression refrigeration machine, in step d., the manipulated variable being the switching-on or switching-off of a compressor.

11. The method as claimed in claim 1, wherein the present operating state of the at least one installation unit is sent to the controller after step d. in order to update the operating state in step a.

12. The method as claimed in claim 1, wherein the FDP algorithm additionally complies with at least one constraint, including a coverage of the load or a system limitation.

13. A model-predictive controller for performing the method steps as claimed in claim 1 for ascertaining an optimum strategy.

14. A computer program, having instructions for implementing the method as claimed in claim 1.
